(19) United States
(12) Patent Application Publication
(10) Pub. No.: US 2025/0391269 A1
(43) Pub. Date: Dec. 25, 2025

(54) REAL TIME TRAFFIC CONTROLS BASED ON MACHINE LEARNED ENERGY CONSUMPTION OF VEHICLES

(71) Applicant: INTERNATIONAL BUSINESS MACHINES CORPORATION, ARMONK, NY (US)

(72) Inventors: Adam Lee Griffin, Cohasset, MN (US); Mohini Setia, Gurugram (IN); Shilpa Shetty, Sydney (AU); Xavier Santolaria, Begnins (CH); Srihari Chandramouli, Irving, TX (US)

(21) Appl. No.: 18/747,748

(22) Filed: Jun. 19, 2024

(51) Int. Cl. G08G 1/09; G08G 1/08; G08G 1/16; H04W 4/44

(52) U.S. Cl. CPC G08G 1/09; G08G 1/08; G08G 1/164; H04W 4/44

(57) ABSTRACT

Provided are techniques for real time traffic controls based on energy consumption of vehicles. A first traffic control message is broadcast, via wireless communication technology, to a first vehicle and a second vehicle. A first vehicle status message from the first vehicle and a second vehicle status message from the second vehicle are received. A first energy consumption of the first vehicle to stop and accelerate to a speed based on the first vehicle status message is calculated. A second energy consumption of the second vehicle to stop and accelerate to the speed based on the second vehicle status message is calculated. It is determined that the first energy consumption is greater than the second energy consumption. A second traffic control message is sent to the first vehicle to proceed through an intersection. A third traffic control message is sent to the second vehicle to stop at the intersection.

### BACKGROUND

Embodiments of the invention relate to real time traffic controls based on machine learned energy consumption of vehicles (e.g., Joule calculations and expenditures). Embodiments of the invention relate to tailored energy optimization systems (e.g., in rural areas).

Traffic lights (i.e., traffic signals or stop lights) having red (stop), yellow (caution), and red (stop) indicators are used to control traffic at intersections (i.e., where two paths (streets, roads, etc.) intersect).

In many cities, smart traffic systems perform congestion prevention and flow optimization to prevent traffic jams. The smart traffic systems also ensure that a smooth flow of traffic transpires throughout each city's network. These smart traffic systems may use sensors and cameras to collect data that is used to determine how to control traffic by adjusting the traffic lights.

### SUMMARY

In accordance with certain embodiments, a computer program product comprising a computer readable storage medium having program code embodied therewith is provided, where the program code is executable by at least one computer processor to perform operations for real time traffic controls based on machine learned energy consumption of vehicles. In such embodiments, a first traffic control message is broadcast, via wireless communication technology, to a first vehicle and a second vehicle that are approaching an intersection. A first vehicle status message is received from the first vehicle and a second vehicle status message from the second vehicle via the wireless communication technology. A first energy consumption of the first vehicle to stop and accelerate to a particular speed based on the first vehicle status message is calculated. A second energy consumption of the second vehicle to stop and accelerate to the particular speed based on the second vehicle status message is calculated. It is determined that the first energy consumption is greater than the second energy consumption. A second traffic control message is sent, via the wireless communication technology, to the first vehicle to proceed through the intersection without stopping. A third traffic control message is sent, via the wireless communication technology, to the second vehicle to stop before entering the intersection until the first vehicle has cleared the intersection.

In accordance with other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for real time traffic controls based on machine learned energy consumption of vehicles. In such embodiments, a first traffic control message is broadcast, via wireless communication technology, to a first vehicle and a second vehicle that are approaching an intersection. A first vehicle status message is received from the first vehicle and a second vehicle status message from the second vehicle via the wireless communication technology. A first energy consumption of the first vehicle to stop and accelerate to a particular speed based on the first vehicle status message is calculated. A second energy consumption of the second vehicle to stop and accelerate to the particular speed based on the second vehicle status message is calculated. It is determined that the first energy consumption is greater than the second energy consumption. A second traffic control message is sent, via the wireless communication technology, to the first vehicle to proceed through the intersection without stopping. A third traffic control message is sent, via the wireless communication technology, to the second vehicle to stop before entering the intersection until the first vehicle has cleared the intersection.

In accordance with yet other embodiments, a computer-implemented method comprising operations is provided for real time traffic controls based on machine learned energy consumption of vehicles. In such embodiments, a first traffic control message is broadcast, via wireless communication technology, to a first vehicle and a second vehicle that are approaching an intersection. A first vehicle status message is received from the first vehicle and a second vehicle status message from the second vehicle via the wireless communication technology. A first energy consumption of the first vehicle to stop and accelerate to a particular speed based on the first vehicle status message is calculated. A second energy consumption of the second vehicle to stop and accelerate to the particular speed based on the second vehicle status message is calculated. It is determined that the first energy consumption is greater than the second energy consumption. A second traffic control message is sent, via the wireless communication technology, to the first vehicle to proceed through the intersection without stopping. A third traffic control message is sent, via the wireless communication technology, to the second vehicle to stop before entering the intersection until the first vehicle has cleared the intersection.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment with an AI traffic controller in accordance with certain embodiments.

FIGS. 3A and 3B illustrate an agent in accordance with certain embodiments.

FIG. 4 illustrates semi-tractor trailers in accordance with certain embodiments.

FIG. 5 illustrates the AI traffic controller at an intersection in accordance with certain embodiments.

FIG. 6 illustrates the AI traffic controller at vehicles that communicate with each other in accordance with certain embodiments.

FIGS. 7A, 7B, and 7C illustrate communication of the AI traffic controller and vehicles approaching an intersection in accordance with certain embodiments.

FIG. 8 illustrates classes of vehicles in accordance with certain embodiments.

FIG. 9 illustrates an example of Basic Safety Message (BSM) communications in accordance with certain embodiments.

FIGS. 10A and 10B illustrate further details of the AI traffic controller at an intersection in accordance with certain embodiments.

FIG. 11 illustrates, in a flowchart, operations for real time traffic controls based on machine learned energy consumption for two vehicles in accordance with certain embodiments.

FIG. 12 illustrates, in a flowchart, operations for real time traffic controls based on machine energy consumption for a plurality of vehicles in accordance with certain embodiments.

FIG. 13 illustrates, in a flowchart, operations for real time traffic controls using wireless connection technology in accordance with certain embodiments.

FIG. 14 illustrates, in a block diagram, details of a machine learning model in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

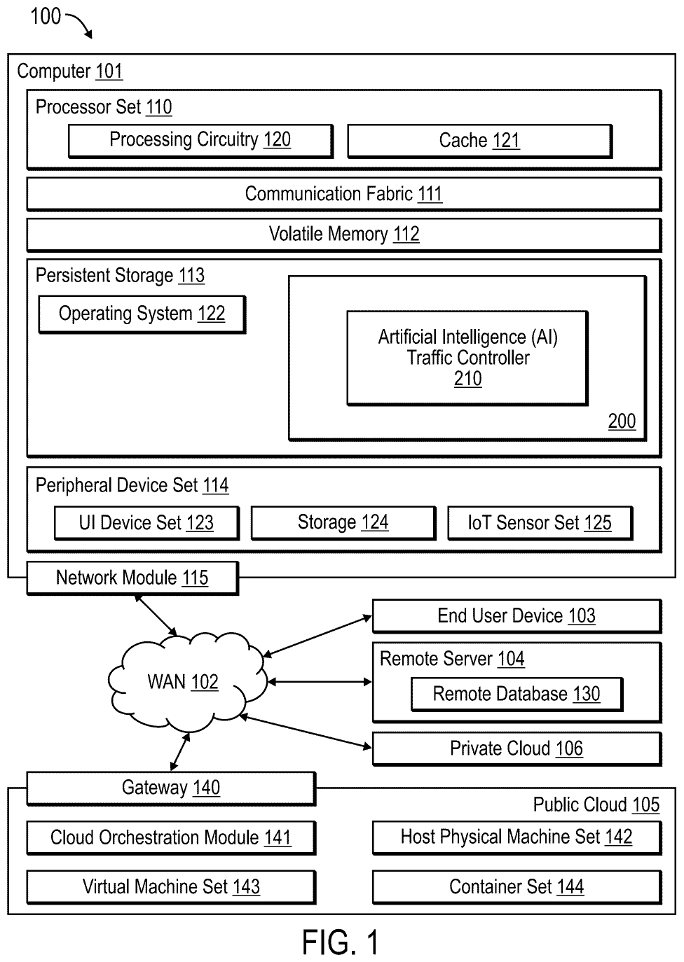

Computing environment 100 of FIG. 1 contains an example of an environment for the execution of at least some of the computer code involved in performing the inventive methods, such as Artificial Intelligence (AI) traffic controller 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

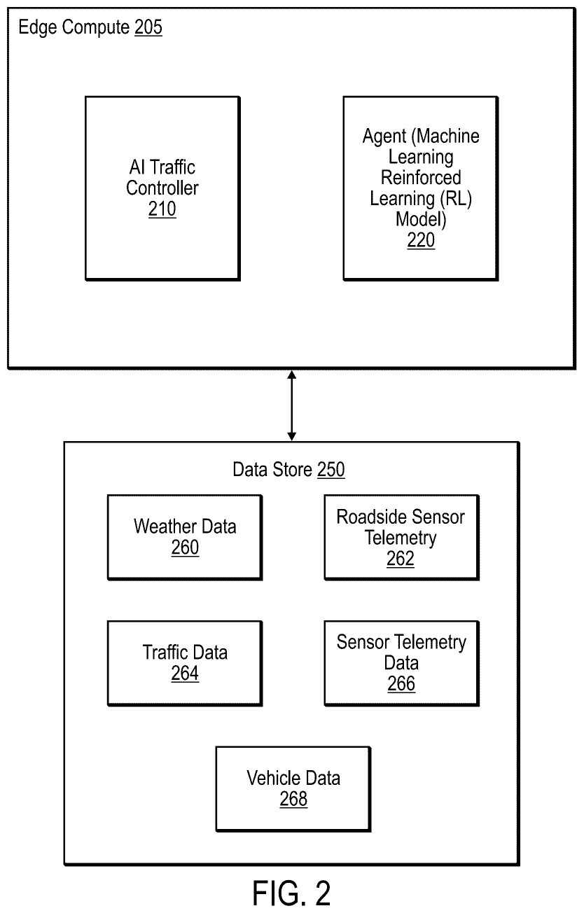

FIG. 2 illustrates a computing environment with an AI traffic controller 210 in accordance with certain embodiments. An edge compute 205 includes the AI traffic controller 210 and an agent 220. In certain embodiments, the agent 220 is a machine learning Reinforced Learning (RL) model). The edge compute 205 is connected to (or includes) a data store 250. The data store 250 includes weather data 260, roadside sensor telemetry 262, traffic data 264, sensor telemetry data 266, and vehicle data 268 (for multiple vehicles).

In certain embodiments, the edge compute 205 is at the traffic light of an intersection. In certain alternative embodiments, vehicles use Vehicle to Vehicle (V2V) communication to negotiate prioritization of which vehicle is to stop and the intersection and which is to continue through the intersection without stopping. In certain embodiments, the edge compute 205 includes the components of the computer 101 in addition to the ones described in FIG. 2.

In certain embodiments, the intersection is the center of two paths intersecting. However, in other embodiments, the intersection may be the center of more than two paths intersection.

In certain embodiments, the AI traffic controller 210 uses the data 260, 262, 264, 266, 268 in the data store 250 and the agent 220 to control the traffic light based on Joule calculations and expenditures.

Joules may represent different forms of energy (e.g., fuel, electricity or other type of energy source). Joules are a standard unit of energy used in the International System of Units (SI), and Joules may be used to measure the energy content of various fuels (such as gasoline, diesel, or natural gas), as well as the energy output of various electrical devices or systems (such as batteries, generators, or power grids). Using Joules as a unit of energy allows for comparison of different types of energy sources on an equal basis. For example, Joules may be used to compare the energy content of a gallon of gasoline to that of a kilowatt-hour of electricity, or to compare the energy output of a solar panel to that of a wind turbine.

By expressing different forms of energy in terms of Joules, the AI traffic controller 210 makes more informed decisions about how to produce, distribute, and consume energy in a sustainable and efficient way.

With embodiments, Joules represents savings/calculations for various vehicle fuel types and how to best optimize traffic patterns to most efficiently consume energy based on specific attributes of those vehicles.

The AI traffic controller 210 focuses on energy, regardless of fuel types/sources or emissions (e.g., CO2 emissions).

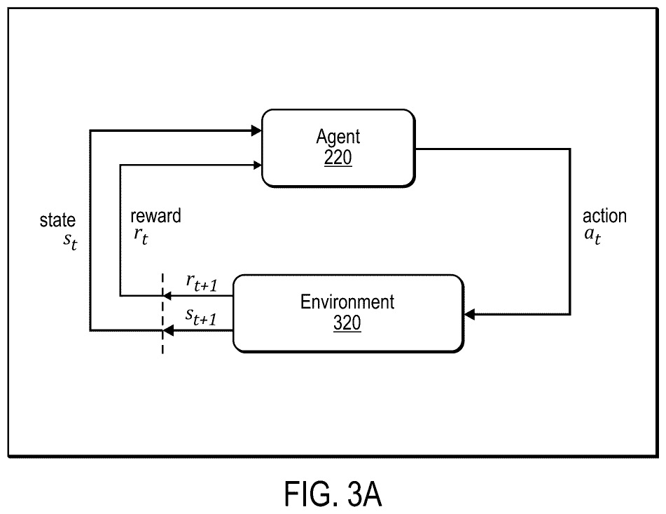

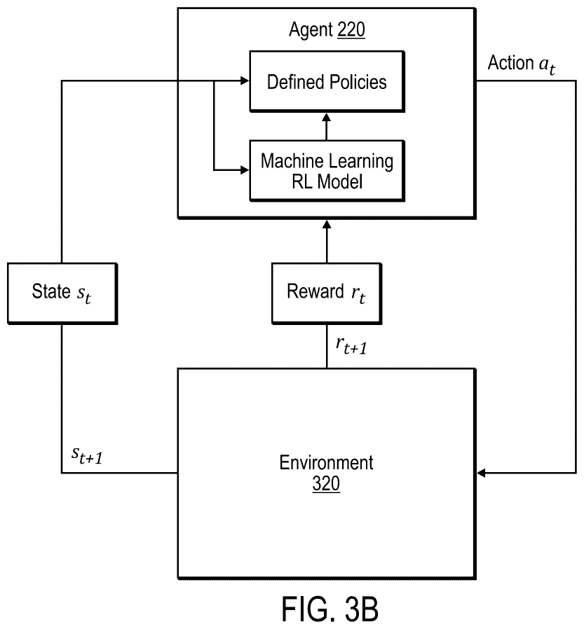

FIGS. 3A and 3B illustrate an agent 220 in accordance with certain embodiments. The agent 220 is connected to an environment 320. The agent 220 receives inputs of a state and a reward from the environment 320 for an action. In certain embodiments, the state may be described as observations and includes data about the vehicles (e.g., from vehicle electronic attribute profiles), roadside generated telemetry, etc.

The state includes inputs from vehicles (e.g., vehicle data 268, inputs from edge devices/sensors (e.g., sensor telemetry data 266), and inputs from cloud services (e.g., weather data 260, roadside sensor telemetry 262, traffic data 264). In certain embodiments, the state includes: vehicle identifiers, acoustic sensors, gross weight, speed trajectory, class, weather, energy fuel source, efficiency, braking performance, road conditions, etc.

There are a set of possible actions that the agent 220 may take, which would be to indicate priorities of the vehicles. In particular the agent 220 may output which vehicle of the vehicles is to have a highest priority. The vehicle that is prioritized has a highest priority relative to the priority of each of the other vehicles and is to go through the intersection without stopping. In certain embodiments, the agent 220 assigns vehicles a Joule rating and/or prioritization rating based on calculations resulting from stop/start energy losses in comparison to vehicle peers within a defined threshold/proximity. The agent 220 prioritizes the vehicle with the greatest Joule loss and sends this prioritization to the AI traffic controller 210. Then, the AI traffic controller 210 sends instructions to de-prioritized vehicles (i.e., the vehicles that have lower priorities relative to the vehicle having the highest priority and are to stop before entering the intersection) to ensure safe traversal of the intersection. In certain embodiments, secondary vehicle systems may override the instructions for safety (e.g., due to errors in the calculations or code). In certain embodiments, if multiple vehicles have the same priority, the agent 220 uses various factors to decide which is to be assigned the highest priority (i.e., prioritized). The agent 220 also receives a reward. The reward function may be based on the Joules consumption of each vehicle, where the agent 220 receives a positive reward for prioritizing vehicles with higher Joule consumption/loss and a negative reward for prioritizing vehicles with lower Joule consumption/loss.

The agent 220 may use Reinforced Learning (RL). There are many RL techniques available (e.g., a Q-learning technique, a Carla technique, a State-Action-Reward-State-Action (SARSA) technique, a policy gradients technique, etc.). With embodiments, the agent 220 may use a particular RL based on the use case and environment.

The AI traffic controller 210 may be used in urban cities and in rural areas.

In the US, there are 89,850,000 cars in urban areas, 83,700,000 cars in suburban areas, and 33,000,000 cars in rural areas. The different types of traffic in different geographies may not require the same type of optimization/flow of traffic. This is because each city, county, state, etc. has a unique mix of traffic flows, types, vehicles, economies, and industries.

For example, in rural areas there may be heavy semi-traffic, logging trucks, feed/seed trucks, farm vehicles, livestock trucks, heavy machinery or equipment transports, wide loads transporting turbines, pre-fab-homes, and various other “heavy” and well-loaded vehicle types. It is inefficient to slow down or to stop these heavier vehicle types based on the energy loss/gain required to do so and leads to a loss of that energy when compared to the lesser energy loss to slow down or stop a typical consumer/family vehicle under the same conditions.

The AI traffic controller 210 optimizes energy usage and losses for alternative environments (e.g., rural areas, urban areas, etc.). In certain embodiments, the AI traffic controller 210 reduces fuel/energy consumption based on how smart vehicles/autonomous vehicles interact. In certain embodiments, the AI traffic controller 210 optimizes and targets tailored-optimizations based on specific geo-requirements. In certain embodiments, the AI traffic controller 210 produces a greener, more sustainable environment by intelligently consuming less energy, and therefore producing less demand on power system grids and/or creation of emissions/pollution. In certain embodiments, the AI traffic controller 210 reduces transport times and prioritizes cargo/freight to further enhance supply chain and logistics challenges.

The less energy that is used, the less energy that needs to be generated for vehicles. Thus, the AI traffic controller 210 provides intelligent energy optimization to reduce demand/production of energy and still equate same/similar results post optimization.

In certain embodiments, the AI traffic controller 210 introduces an intelligently optimized traffic control platform that ingests specialized/personalized vehicle attributes and/or characteristics and makes energy saving determinations of each vehicle's prioritization at intersections or controlled roadway junctions based on energy/Joule consumption specific to each vehicle's electronic attribute profile.

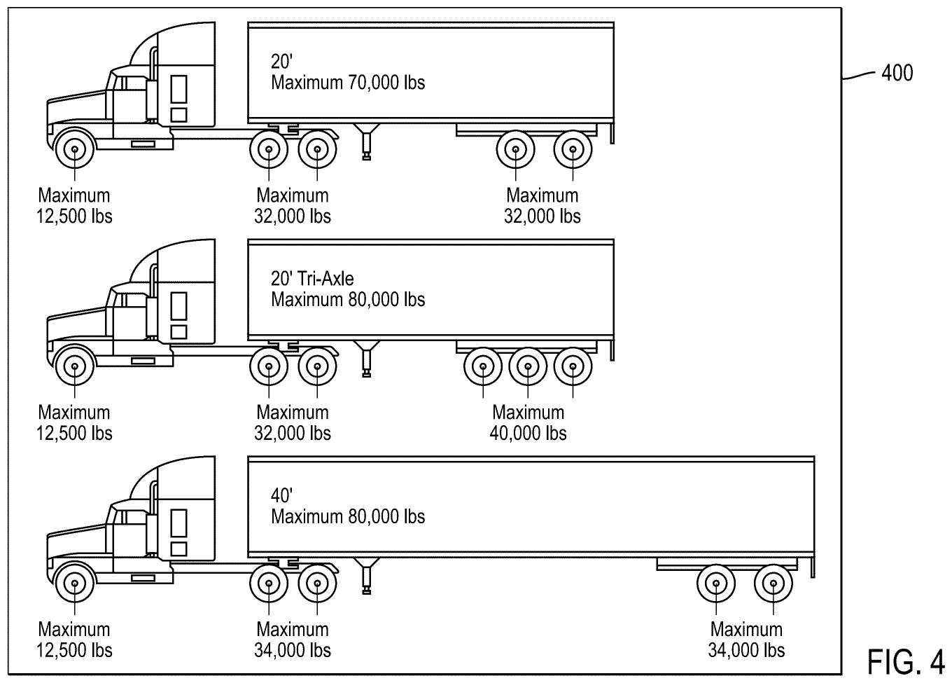

FIG. 4 illustrates semi-tractor trailers 400 in accordance with certain embodiments. These semi-tractor trailers 400 are upwards of 80,000 pounds (lbs.) The AI traffic controller 210 takes into consideration the energy used to stop and re-start 80,000 lbs.

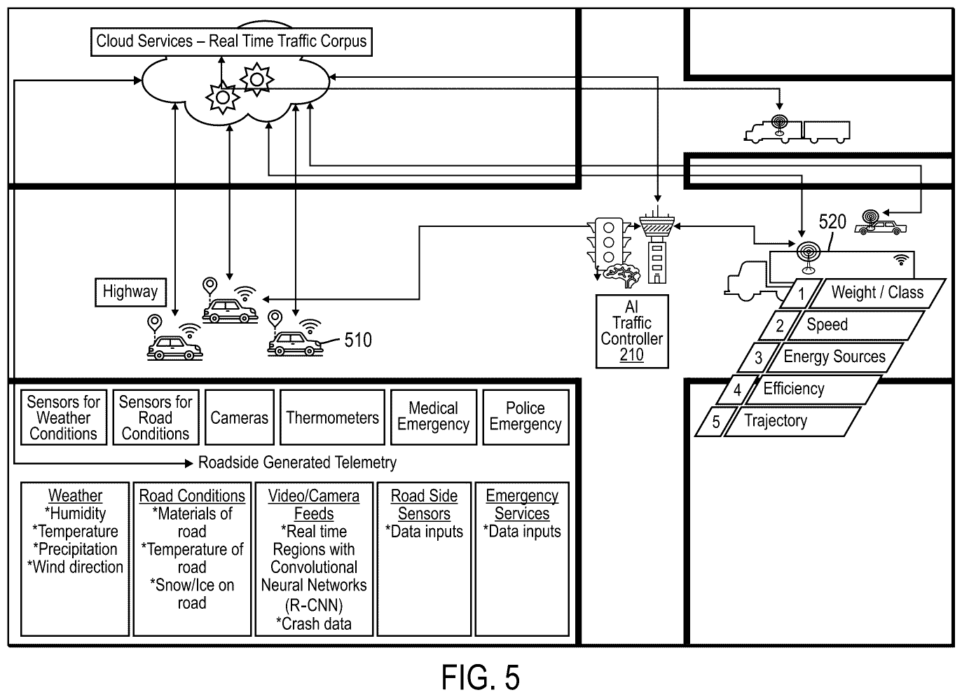

FIG. 5 illustrates a flow of processing for the AI traffic controller 210 at an intersection in accordance with certain embodiments. The AI traffic controller 210 is at an intersection of a highway. In certain embodiments, the AI traffic controller 210 is part of a smart light or part of an AI power flight control tower. In FIG. 5, both a passenger vehicle 510 (e.g., a family car) and a semi-truck 520 are approaching the intersection.

In motion, the kinetic energy of the passenger vehicle 510 (which is 3000 pounds) traveling at 65 mph is 57,4482 Joules. This represents less than 4% of the kinetic energy of the semi-truck 520. To resume acceleration (e.g., from a stopped position) also uses energy. The AI traffic controller 210 calculates the amount of energy used to accelerate the passenger vehicle 510 of mass 3,000 pounds (or approximately 1,360 kilograms) from rest to a speed of 65 miles per hour (or approximately 29 meters per second) using the following equation:

$$E = ( 1 / 2 ) * m * v \hat{} 2$$

Where E is the energy used, m is the mass of the passenger vehicle 510, and v is the final velocity.

That is, the energy used E is equal to half of the mass times the velocity squared. That is, E is equal to the kinetic energy of the object. E is the amount of energy used to get an object of mass m moving at speed v.

To use this equation, the AI traffic controller 210 converts the mass of the passenger vehicle 510 from pounds to kilograms, which is done by dividing by 2.20462, and the mass of the passenger vehicle 510 is approximately 1,360 kg.

Next, the AI traffic controller 210 converts the final velocity from miles per hour to meters per second by multiplying by 0.44704, and the final velocity is approximately 29 m/s. Substituting these values into the equation results in:

$$E = ( 1 / 2 ) * m * v \hat{} 2$$

$$E = ( 1 / 2 ) * 1 , 360 kg * ( 29 m / s ) \hat{} 2$$

$$E = 559 , 402 Joules$$

Therefore, the energy used to accelerate the passenger vehicle 510 weighing 3,000 pounds from rest to 65 miles per hour is approximately 559,402 Joules.

In motion, using mass×velocity=kinetic energy, the semi-truck 520 weighing 80,000 pounds and driving 65 miles per hour has a kinetic energy of approximately 15,319,522 Joules.

To calculate the energy required to accelerate the semi-truck 520 from rest to 65 miles per hour, the AI traffic controller 210 determines the mass of the semi-truck 520 in kilograms, as well as the distance that it takes to reach that speed. The AI traffic controller 210 converts the weight of the semi-truck 520 from pounds to kilograms: 80,000 pounds=36,287.39 kilograms. Assuming that the semi-truck 520 has a constant acceleration throughout the acceleration process, the AI traffic controller 210 uses the following formula to calculate the energy used:

$$E = ( 1 / 2 ) * m * v \hat{} 2$$

Where E is the energy, m is the mass of the semi-truck 520, and v is the velocity.

The AI traffic controller 210 converts the velocity from miles per hour to meters per second: 65 miles per hour=29.0576 meters per second.

Then, the AI traffic controller 210 plugs in the values and solves for E:

$$E = ( 1 / 2 ) ( 36 , 287.39 kg ) ( 29.0576 m / s ) \hat{} 2 E = 62 , 048 , 126.4 Joules .$$

Therefore, the energy used to accelerate the semi-truck 520 weighing 80,000 pounds from rest to 65 miles per hour is approximately 62,048,126.4 Joules.

The AI traffic controller 210 subtracts 559,402 Joules from 62,048,126.4 Joules to obtain: 61,488,724 Joules. This represents the difference in energy used to accelerate a semi-truck 520 weighing 80,000 pounds from rest to 65 miles per hour (which requires 62,048,126.4 Joules) and a family car 520 weighing 3,000 pounds (which requires 559,402 Joules) to reach the same speed.

The AI traffic controller 210 determines that the traffic types to be prioritized are ones that use more energy to accelerate from a stopping (resting) position at an intersection to optimize for fuel efficiencies.

From an energy optimization standpoint (e.g., for carbon-based fuel, hybrid, hydrogen, electric or other energy), the AI traffic controller 210 determines that larger payloads, freight, logging trucks, and other vehicles using more energy to accelerate are to be priorities to move on through a smart intersection prior to passenger vehicle.

In the US there are about 4 million semi-trucks. 4,000,000 semi-trucks×61,488,724 Joules expended/semi-truck stop and start equates to a total Joule expenditure of 245,954,896,000,000 Joules. The approximate energy used by 4 million semi-trucks in kWh=245,954,896,000,000 Joules/3,600,000 (the number of Joules in one kilowatt-hour). The total energy used by 4 million semi-trucks in kWh=68,320,804 kWh. It is possible to compare the energy used by the semi-trucks to the energy consumption of an average household by dividing the total energy used by the semi-trucks by the average energy consumption of a household:

$$Energy used by 4 million trucks / Average household energy consumption = 68 , 320 , 804 kWh / 9 , 190 kWh per household$$

The energy used by 4 million trucks is approximately the energy used by 7,431 households. Therefore, the energy used by 4 million trucks stopping and starting one time at an intersection is equivalent to the annual energy consumption of approximately 7,431 households.

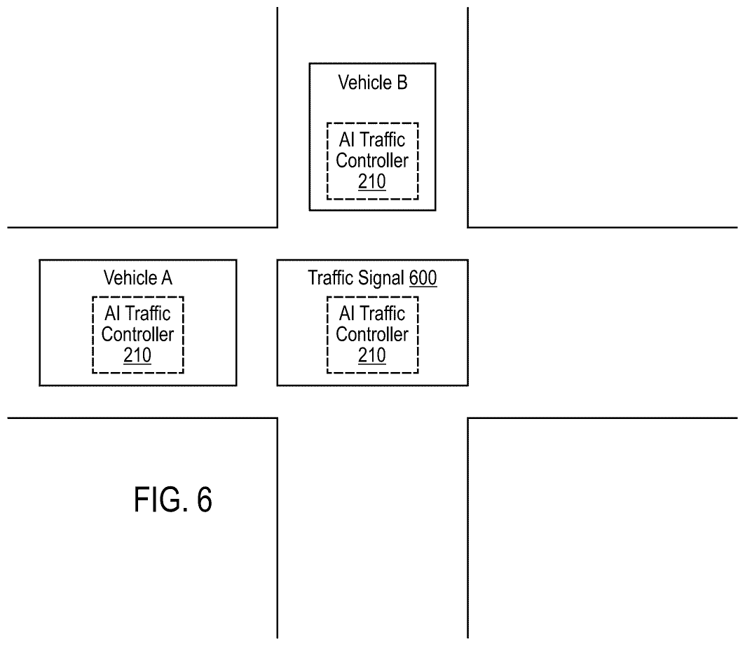

FIG. 6 illustrates the AI traffic controller 210 at vehicles that communicate with each other in accordance with certain embodiments. In FIG. 6, vehicle A has an AI traffic controller 210 and vehicle B has an AI traffic controller 210. In certain embodiments, the AI traffic controller 210 of vehicle A is able to communicate with the AI traffic controller 210 of vehicle B to determine which vehicle is to continue through the intersection that the vehicles are approaching, while the other vehicle stops. In certain embodiments, the AI traffic controller 210 of vehicle A and the AI traffic controller 210 of vehicle B send information to the AI traffic controller 210 of a traffic light 600 that is located at the intersection, and the AI traffic controller 210 of the traffic light 600 determines which vehicle is to continue through the intersection and which vehicle is to stop at the intersection.

In certain embodiments, the vehicles share communications with traffic infrastructure, such as the AI traffic controller 210 at a traffic light. For example, the AI traffic controller 210 may issue Traffic Signal Phase and Timing (SPaT) messages to the vehicles to provide information about the current state of traffic signals at an intersection, which includes the time remaining until the next signal phase.

In certain embodiments, Vehicle-to-Infrastructure (V2I) communication is a communication technology that enables vehicles to exchange data with the surrounding infrastructure, such as the AI traffic controller 210 at a traffic signal, road signs, bridges, railroad crossing, and other infrastructure components. The V2I communication is a wireless communication technology (“wireless communication”) that enables the AI traffic controller 210 and the vehicles to exchange information with each other in real-time. In certain embodiments, V2I communication works by using Dedicated Short-Range Communication (DSRC) or cellular-based communication protocols to transmit data between the AI traffic controller 210 and vehicles. V2I communication may be used to provide vehicles with real-time traffic information, road condition alerts, and other safety-related information. V2I technology may also be used to improve traffic flow by allowing the traffic controller 210 at a traffic signal to communicate with vehicles to indicate which vehicle is to stop at the intersection and which vehicle is to continue through the intersection without stopping. DSRC may be described as a wireless communication technology that operates in the 5.9 Giga Hertz (GHz) frequency band, which is reserved for transportation-related applications.

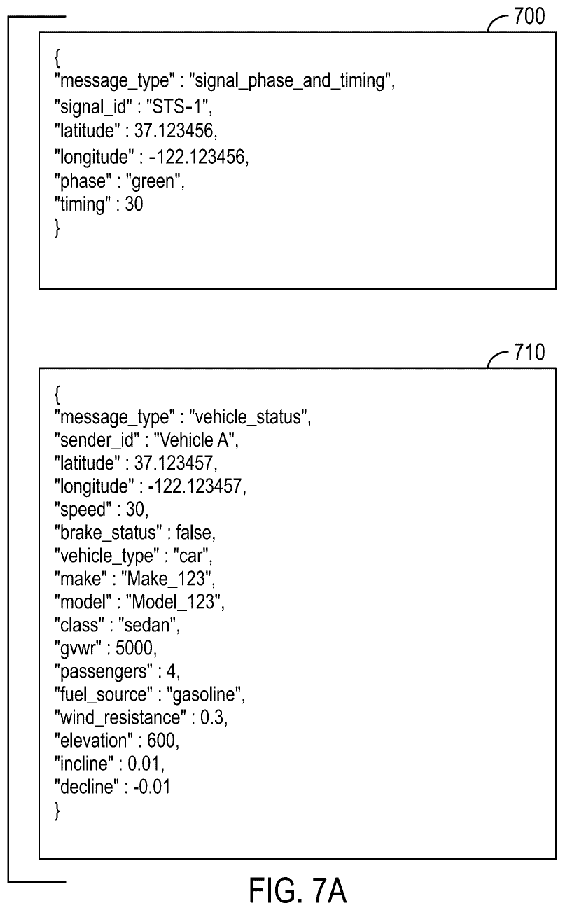

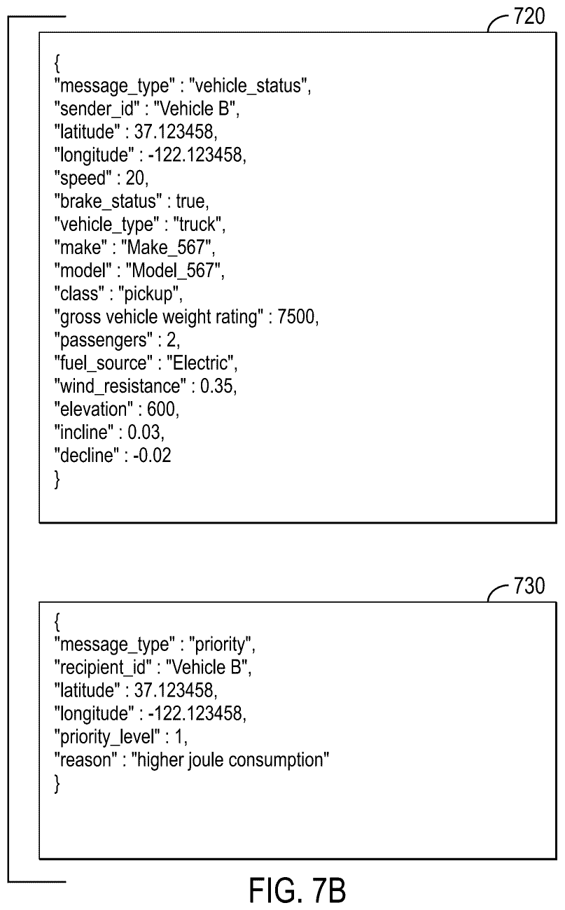

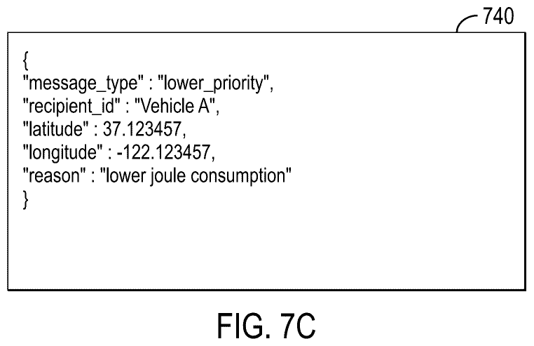

FIGS. 7A, 7B, and 7C illustrate communication of the AI traffic controller 210 and vehicles approaching an intersection in accordance with certain embodiments. For example, vehicle A and vehicle B are approaching an intersection with potential collision/priority conflicts. The AI traffic controller 210 of the traffic signal {STS-1} sends a “signal phase and timing” message 700 (i.e., a traffic control message), via wireless communication technology, to the AI traffic controller 210 of vehicle A and to the AI traffic controller 210 of vehicle B.

In certain embodiments, the AI traffic controller 210 of vehicle A and the AI traffic controller 210 of vehicle B receive the “signal phase and timing” message 700 via the wireless communication technology. Then, the AI traffic controller 210 of vehicle A sends a “vehicle status” message 710 (i.e., with data from the vehicle electronic attribute profile of vehicle A), via the wireless communication technology, to the AI traffic controller of the traffic signal, and the AI traffic controller 210 of vehicle B sends a “vehicle status” message 720 (i.e., with data from the vehicle electronic attribute profile of vehicle B), via the wireless communication technology, to the AI traffic controller 210 of the traffic signal.

In certain embodiments, vehicle A and vehicle B each send the “vehicle status” messages 710, 720, via the wireless communication technology, to the AI traffic controller 210 of the traffic signal, including respective attributes that calculate the near-real-time Joule consumption and predicted Joule consumption estimates for stopping and re-starting at the intersection. The AI traffic controller 210 of the traffic signal receives the “vehicle status” messages 710, 720, via the wireless communication technology, and prioritizes the vehicles based on their predicted Joule consumption estimates. The AI traffic controller 210 of the traffic signal sends a “priority” message 730 (i.e., another traffic control message), via the wireless communication technology, to the AI traffic controller 210 of vehicle B with instructions to proceed through the intersection first. The AI traffic controller 210 of the traffic signal sends a “lower priority” message 740 (i.e., another traffic control message), via the wireless communication technology, to the AI traffic controller 210 of vehicle A with instructions to slow down and stop so that vehicle B may continue through the intersection.

The AI traffic controller 210 of vehicle B receives the “priority” message 730, via the wireless communication technology, from the AI traffic controller 210 of the traffic signal and proceeds through the intersection. The AI traffic controller 210 of vehicle A receives the “lower priority” message 740, via the wireless communication technology, from the AI traffic controller 210 of the traffic signal and waits (i.e., stops at the intersection) to enable vehicle B to clear the intersection before vehicle A proceeds into the intersection.

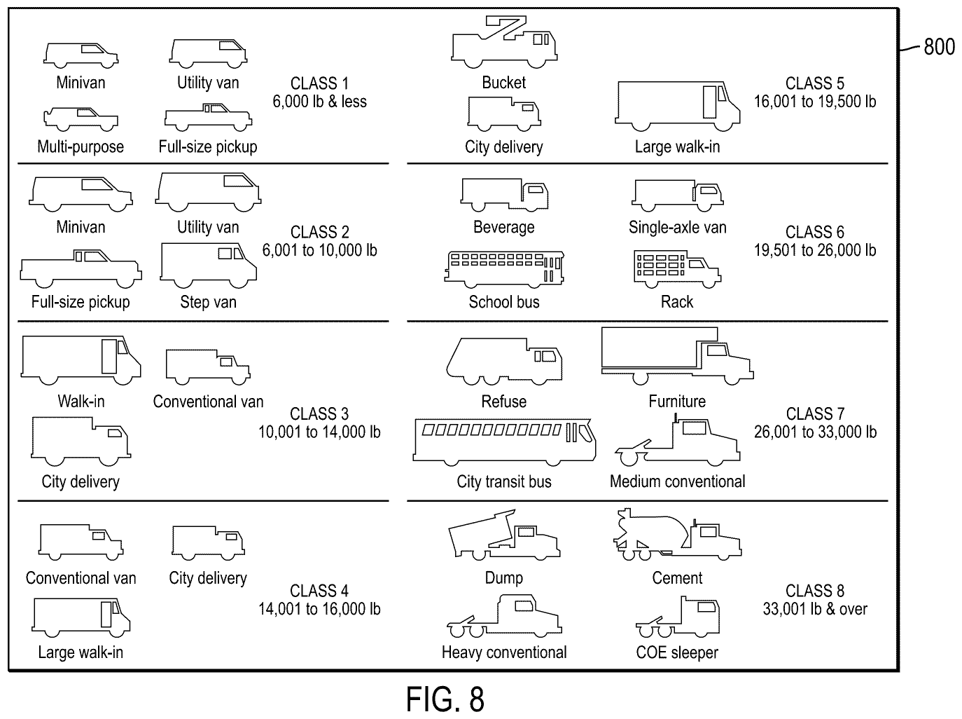

FIG. 8 illustrates classes of vehicles 800 in accordance with certain embodiments. In FIG. 8, classes of vehicles 800 and their weights are provided.

In certain embodiments, the AI traffic controller 210 is a dynamic traffic management prioritization system at an intersection or junction point based on specific/personalized vehicle attributes and the correlated prediction of energy consumption of vehicles to resume/return to previous speed from a stopped state, where those requirements are expressed and prioritized across a convergence of a plurality vehicles in a real/near time state.

In certain embodiments, based on the predicted energy consumption of the vehicle, the AI traffic controller 210 manages the movement of vehicles across the intersection to minimize the impact of energy consumption and lessen demand on fuel sources (e.g., electrical grid-dependence and/or fossil fuels).

In certain embodiments, the AI traffic controller 210 provides a traffic management system for a learning module and real time data connectivity ecosystem (Internet of Things (IoT) roadway data) that may be optimized and customized relevant to a region/geography, industrial sector corridor, or specific to traffic attributes, municipality, and/or government regulation.

In certain embodiments, each of the vehicles is equipped with an electronic attribute profile that includes information such as: Vehicle Identification Number (VIN) of the vehicle, manufacturer/model of the vehicle, weight of the vehicle, class of the vehicle, and other relevant details for the vehicle. In certain embodiments, if some fields of the electronic attribute profile are empty, then data may be inferred for these fields via data derived from the vehicle's data architecture. In certain embodiments, vehicle specific or real-time generated information is stored in one of several Electronic Control Units (ECUs), Electronic Control Modules (ECMs) or Powertrain Control Modules (PCMs) found within the vehicle. These interconnected modules consume data from an array of internal/external sensors that give the vehicle data about roadway peers, infrastructure, and environmental surroundings.

In certain embodiments, the vehicles are equipped with Vehicle-to-Vehicle (V2V) communication, which is a wireless communication technology that enables vehicles to exchange information with each other in real-time. This technology is designed to improve road safety, traffic efficiency, and enable new applications and services in the automotive industry. In certain embodiments, V2V communication works by using DSRC or cellular-based communication protocols to transmit data between vehicles.

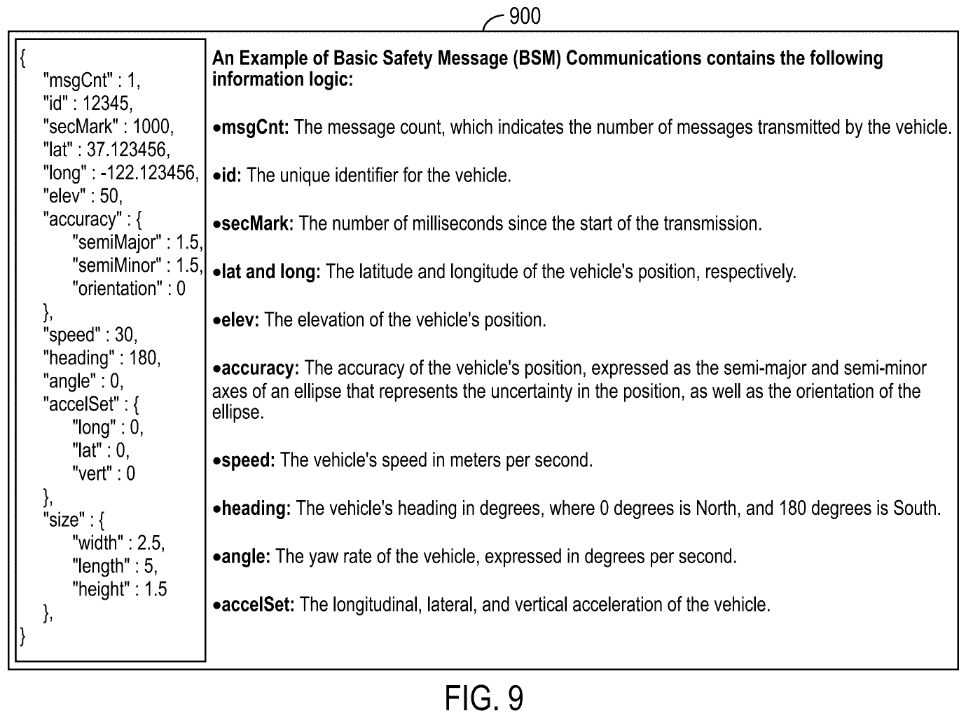

In certain embodiments, V2V equipped vehicles also broadcast Basic Safety Messages (BSMs) via DSRD or other wireless communication technology. BSMs include information about the vehicle's position, speed, acceleration, and heading. In certain embodiments, these messages are typically broadcast by a vehicle every few milliseconds and are used to alert nearby vehicles of potential collision risks. FIG. 9 illustrates an example of BSM communications 900 in accordance with certain embodiments.

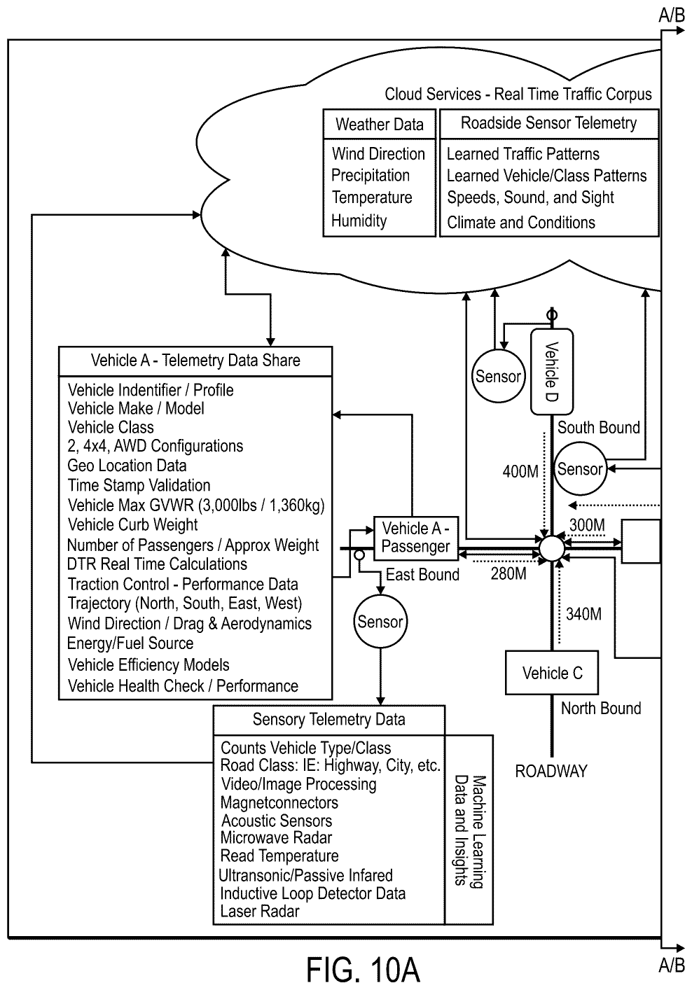

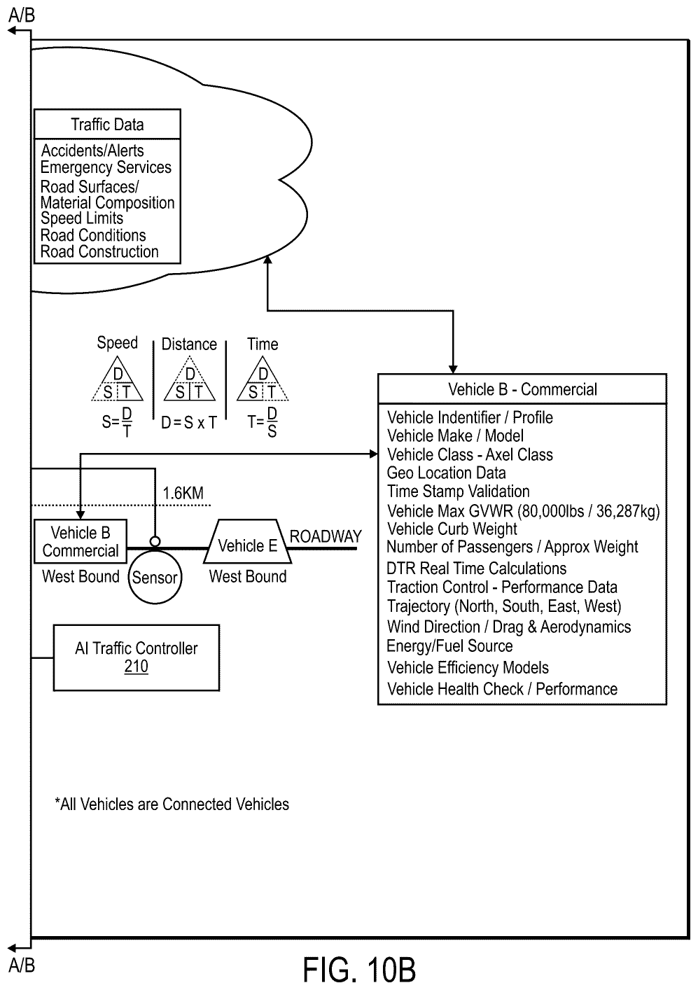

FIGS. 10A and 10B illustrate further details of the AI traffic controller 210 at an intersection in accordance with certain embodiments. In certain embodiments, the AI traffic controller 210 is within edge compute traffic infrastructure components (e.g., a Smart Traffic Signal (STS-1)). The AI traffic controller 210 identifies an applicable roadside sensor telemetry network for data acquisition and inclusion into a traffic control platform. The AI traffic controller 210 enables a data lake (a centralized repository, such as a cloud infrastructure). The AI traffic controller 210 enables relevant heterogenous protocol sets (e.g., Wireless Access in Vehicular Environments (WAVE) communications/DSRC protocols, Cellular Vehicle-to Everything (C-V2X), etc. The AI traffic controller 210 connects to the data lake via connectivity/Application Programming Interfaces (APIs).

In certain embodiments, the AI traffic controller 210 detects, with the roadside sensor telemetry network, that a first vehicle and a second vehicle are approaching an intersection in a potential conflict (e.g., they may collide if they both enter the intersection at the same time). The AI traffic controller 210 sends a phase and timing message to the first vehicle and the second vehicle in response to detecting the potential conflict. The AI traffic controller 210 receives a first vehicle status message from the first vehicle in response to the phase and timing message, and a second vehicle status message from the second vehicle in response to the phase and timing message. The AI traffic controller 210 calculates first and second predicted joule expenditures for a stop and re-start at the intersection of the first and second vehicles. The AI traffic controller 210 sends a prioritized message to the first vehicle based on the first predicted joule expenditure being greater than the second predicted joule expenditure. The AI traffic controller 210 sends a lower priority message to the second vehicle based on the first predicted joule expenditure being greater than the second predicted joule expenditure.

In FIGS. 10A and 10B the vehicles are connected vehicles (i.e., are able to communicate with each other bidirectionally), and the vehicles communicate with one or more sensors, with the cloud services, and with the AI traffic controller 210.

In certain embodiments, calculating the predicted joule expenditure includes calculating a current in-motion kinetic energy of the vehicle and an acceleration kinetic energy from 0 to a speed.

In certain embodiments, the vehicle status message includes the following data: a sender identifier (sender_id), a latitude and a longitude (indicating a location of the vehicle), a speed of the vehicle, the brake status of the vehicle (brake_status), a type of the vehicle (vehicle_type), a make of the vehicle, a model of the vehicle, a class of the vehicle, a gross vehicle weight rating, passengers in the vehicle, a fuel source of the vehicle (fuel_source), a wind resistance of the vehicle (wind_resistance), an elevation of the location, and an incline or decline of the location.

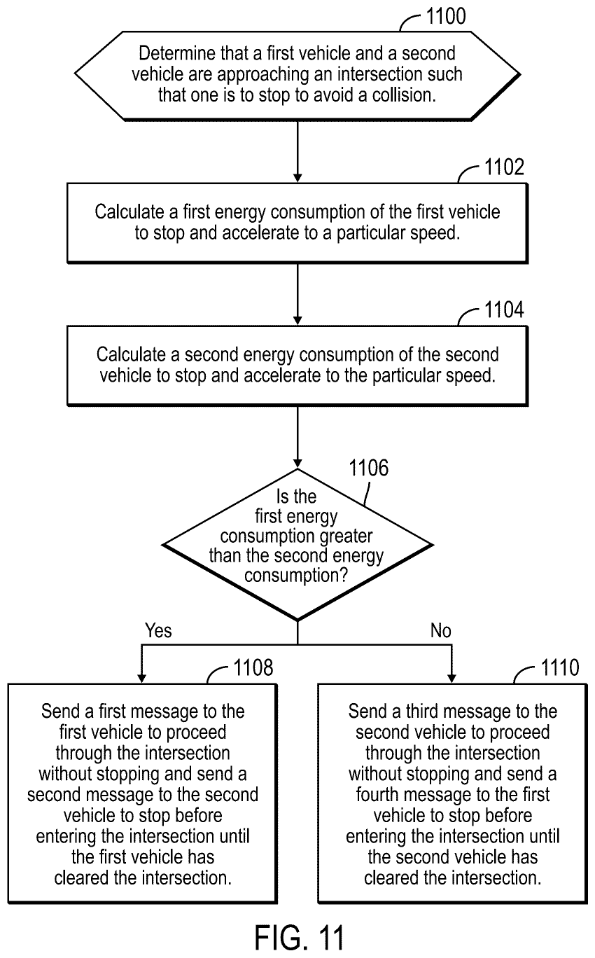

FIG. 11 illustrates, in a flowchart, operations for real time traffic controls based on machine learned energy consumption for two vehicles in accordance with certain embodiments. Control begins at block 1100 with the AI traffic controller 210 determines that a first vehicle and a second vehicle are approaching an intersection such that one is to stop to avoid a collision. In block 1102, the AI traffic controller 210 calculates a first energy consumption of the first vehicle to stop and accelerate to a particular speed. In block 1104, the AI traffic controller 210 calculates a second energy consumption of the second vehicle to stop and accelerate to the particular speed.

In block 1106, the AI traffic controller 210 determines whether the first energy consumption is greater than the second energy consumption. In block 1108, if the first energy consumption is greater than the second energy consumption, the AI traffic controller 210 ends a first message to the first vehicle to proceed through the intersection without stopping and sends a second message to the second vehicle to stop before entering the intersection until the first vehicle has cleared the intersection. In block 1110, if the first energy consumption is less than the second energy consumption, the AI traffic controller 210 sends a third message to the second vehicle to proceed through the intersection without stopping and sends a fourth message to the first vehicle to stop before entering the intersection until the second vehicle has cleared the intersection.

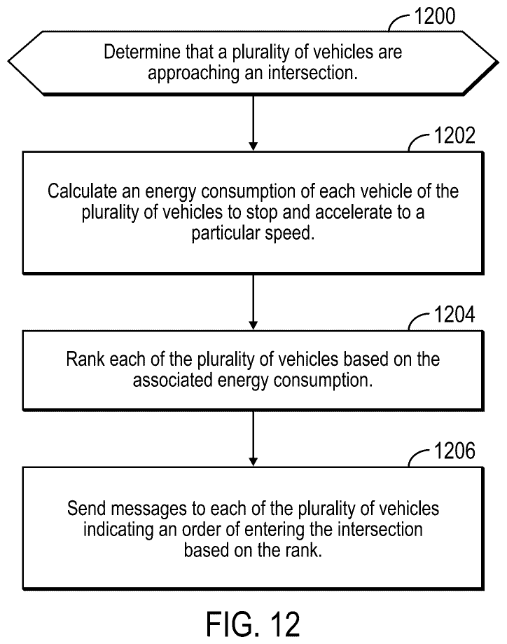

FIG. 12 illustrates, in a flowchart, operations for real time traffic controls based on machine energy consumption for a plurality of vehicles in accordance with certain embodiments. Control begins at block 1200 with the AI traffic controller 210 determines that a plurality of vehicles (e.g., three or more) are approaching an intersection. In block 1202, the AI traffic controller 210 calculates an energy consumption of each vehicle of the plurality of vehicles to stop and accelerate to a particular speed. In block 1204, the AI traffic controller 210 ranks each of the plurality of vehicles based on the associated energy consumption. In block 1206, the AI traffic controller 210 sends messages to each of the plurality of vehicles indicating an order of entering the intersection based on the rank.

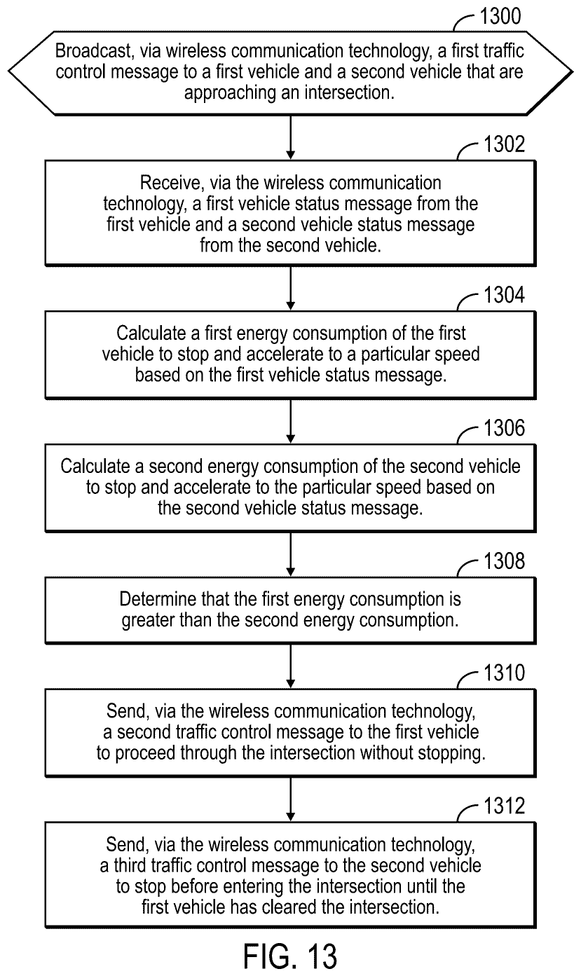

FIG. 13 illustrates, in a flowchart, operations for real time traffic controls using wireless connection technology in accordance with certain embodiments. Control begins at block 1300 with the AI traffic controller 210 broadcasting, via wireless communication technology (“wireless communication”), a first traffic control message to a first vehicle and a second vehicle that are approaching an intersection. In block 1302, the AI traffic controller 210 receives, via the wireless communication technology, a first vehicle status message from the first vehicle and a second vehicle status message from the second vehicle. In block 1304, the AI traffic controller 210 calculates a first energy consumption of the first vehicle to stop and accelerate to a particular speed based on the first vehicle status message (i.e., using data in the first vehicle status message). In block 1306, the AI traffic controller 210 calculates a second energy consumption of the second vehicle to stop and accelerate to the particular speed based on the second vehicle status message (i.e., using data in the second vehicle status message). In block 1308, the AI traffic controller 210 determines that the first energy consumption is greater than the second energy consumption. In block 1310, the AI traffic controller 210 sends, via the wireless communication technology, a second traffic control message to the first vehicle to proceed through the intersection without stopping. In block 1312, the AI traffic controller 210 sends, via the wireless communication technology, a third traffic control message to the second vehicle to stop before entering the intersection until the first vehicle has cleared the intersection. That is, the second vehicle stops before entering the intersection, determines when the first vehicle has cleared (i.e., left or cross through) the intersection, and then enters the intersection to pass through.

In certain embodiments, at a later time, the AI traffic controller 210 determines that the first vehicle and a third vehicle are approaching the intersection, calculates a third energy consumption of the third vehicle to stop and accelerate to the particular speed, determines that the first energy consumption is less than the third energy consumption; sends, via the wireless communication technology, a fourth traffic control message to the first vehicle to stop before entering the intersection until the third vehicle has cleared the intersection, and sends, via the wireless communication technology, a fifth traffic control message to the third vehicle to proceed through the intersection. In certain embodiments, the AI traffic controller 210 may access stored data that identifies the first energy consumption of the first vehicle when the first vehicle approaches the intersection at a later time, while in other embodiments, the AI traffic controller 210 re-calculates the first energy consumption of the first vehicle.

In certain embodiments, the AI traffic controller 210 determines that the first energy consumption and the second energy consumption are equal and uses one or more factors to determine which of the first vehicle and the second vehicle is to continue through the intersection without stopping, where the one or more factors comprise weather conditions, road conditions, camera feeds, traffic data, and vehicle data of the first vehicle and the second vehicle.

In certain embodiments, the AI traffic controller 210 performs the determinations and calculations at an edge compute that is part of a traffic light and that receives data from the first vehicle and the second vehicle.

In certain embodiments, the AI traffic controller 210 of the first vehicle and the AI traffic controller 210 of the second vehicle communicate with vehicle to vehicle communications to determine which of the first vehicle and the second vehicle is to continue through the intersection without stopping.

In certain embodiments, the AI traffic controller 210 determines that three or more new vehicles are approaching the intersection, ranks each of the new vehicles based on energy consumption associated with those new vehicles, and sends via the wireless communication technology, new traffic control messages to each of the new vehicles to indicate an order of entering the intersection.

In certain embodiments, a machine learning model (agent 220) receives inputs of a state and a reward for an activity and outputs a highest priority for the first vehicle to indicate that the first vehicle is to proceed through the intersection without stopping.

In certain embodiments, the AI traffic controller 210 uses machine learning selection (e.g., Reinforces Learning (RL) Q-Learning) with the agent 220. The AI traffic controller 210 defines state space, with current known possible states. The AI traffic controller 210 defines action space, with current known possible actions. The AI traffic controller 210 defines a reward function and defines which actions are desirable or suppressed. The AI traffic controller 210 initializes a table (e.g., a Q-table) and maps each state-action pair to a reward value (e.g., to a Q-value), which represents the expected reward for taking an action in a specified state.

In certain embodiments, the AI traffic controller 210 implements the Q-learning technique/Bellman equations. In certain embodiments, the AI traffic controller 210 trains the agent 220 (a machine learning RL model) on identified telemetry/use cases. In certain embodiments, the AI traffic controller 210 tests the agent 220 on training data, sample data and/or generated synthetic data. In certain embodiments, the AI traffic controller 210 optimizes/refines/adjusts rewards until a desired confidence is achieved (where the desired confidence may be relative to a confidence threshold or selected by a system administrator).

In certain embodiments, the AI traffic controller 210 uses the following function:

$$Q ( s , a ) = R ( s , a ) + γ * max ( Q ( {s}^{′} , {a}^{′} ) )$$

Where:
Q(s, a) is the Q-value for a particular state-action pair (s, a);
R(s, a) is the immediate reward obtained by taking action a in state s;
γ (gamma) is the discount factor that determines the importance of future rewards relative to immediate rewards;
max(Q(s′, a′)) is the maximum Q-value for all possible actions a′ in the next state s′;

In certain embodiments, the AI traffic controller 210 performs energy optimization calculations for use in determining vehicle prioritization through an intersection and how to produce, distribute, and consume energy in a sustainable and efficient way.

In certain embodiments, the AI traffic controller 210 calculates first/second predicted joule expenditures for a stop and re-start at the intersection of first/second vehicles. The AI traffic controller 210 sends a prioritized message to the first vehicle based on the first predicted joule expenditure being greater than the second.

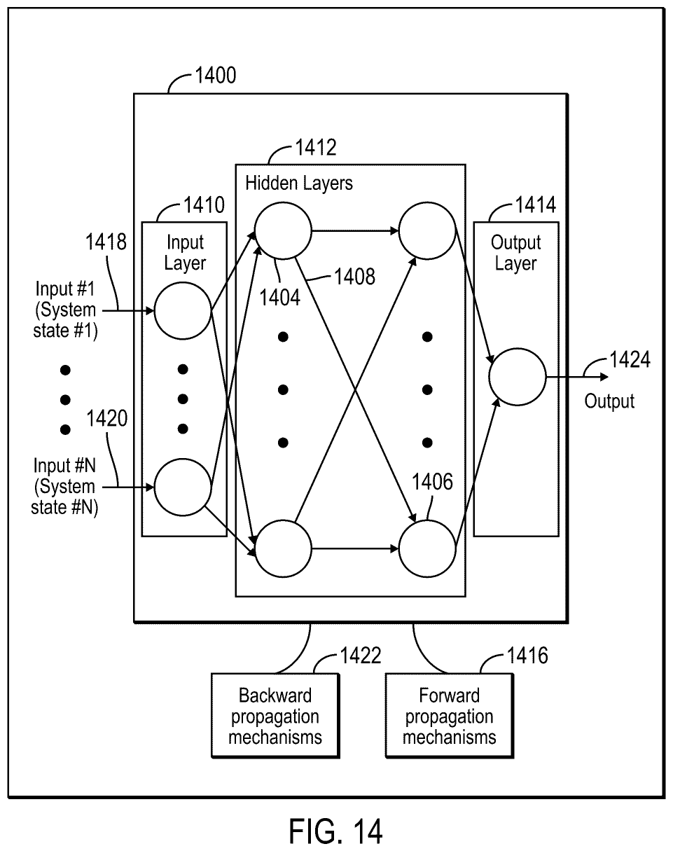

FIG. 14 illustrates, in a block diagram, details of a machine learning model 1400 in accordance with certain embodiments. In certain embodiments, the agent 220 is implemented using the components of the machine learning model 1400.

The machine learning model 1400 may comprise a neural network with a collection of nodes with links connecting them, where the links are referred to as connections. For example, FIG. 14 shows a node 1404 connected by a connection 1408 to the node 1406. The collection of nodes may be organized into three main parts: an input layer 1410, one or more hidden layers 1412, and an output layer 1414.

The connection between one node and another is represented by a number called a weight, where the weight may be either positive (if one node excites another) or negative (if one node suppresses or inhibits another). Training the machine learning model 1400 entails calibrating the weights in the machine learning model 1400 via mechanisms referred to as forward propagation 1416 and backward propagation 1422. Bias nodes that are not connected to any previous layer may also be maintained in the machine learning model 1400. A bias may be described as an extra input of 1 with a weight attached to it for a node.

In forward propagation 1416, a set of weights are applied to the input data 1418 . . . 1420 to calculate the output 1424. For the first forward propagation, the set of weights may be selected randomly or set by, for example, a system administrator. That is, in the forward propagation 1416, embodiments apply a set of weights to the input data 1418 . . . 1420 and calculate an output 1424.

In backward propagation 1422 a measurement is made for a margin of error of the output 1424, and the weights are adjusted to decrease the error. Backward propagation 1422 compares the output that the machine learning model 1400 produces with the output that the machine learning model 1400 was meant to produce, and uses the difference between them to modify the weights of the connections between the nodes of the machine learning model 1400, starting from the output layer 1414 through the hidden layers 1412 to the input layer 1410, i.e., going backward in the machine learning model 1400. In time, backward propagation 1422 causes the machine learning model 1400 to learn, reducing the difference between actual and intended output to the point where the two come very close or coincide.

The machine learning model 1400 may be trained using backward propagation to adjust weights at nodes in a hidden layer to produce adjusted output values based on the provided inputs 1418 . . . 1420. A margin of error may be determined with respect to the actual output 1424 from the machine learning model 1400 and an expected output to train the machine learning model 1400 to produce the desired output value based on a calculated expected output. In backward propagation, the margin of error of the output may be measured and the weights at nodes in the hidden layers 1412 may be adjusted accordingly to decrease the error.

Backward propagation may comprise a technique for supervised learning of artificial neural networks using gradient descent. Given an artificial neural network and an error function, the technique may calculate the gradient of the error function with respect to the artificial neural network's weights.

Thus, the machine learning model 1400 is configured to repeat both forward and backward propagation until the weights of the machine learning model 1400 are calibrated to accurately predict an output.

The machine learning model 1400 implements a machine learning technique such as decision tree learning, association rule learning, artificial neural network, inductive programming logic, support vector machines, Bayesian models, etc., to determine the output value 1424.

In certain machine learning model 1400 implementations, weights in a hidden layer of nodes may be assigned to these inputs to indicate their predictive quality in relation to other of the inputs based on training to reach the output value 1424.

With embodiments, the machine learning model 1400 is a neural network, which may be described as a collection of “neurons” with “synapses” connecting them.

With embodiments, there may be multiple hidden layers 1412, with the term “deep” learning implying multiple hidden layers. Hidden layers 1412 may be useful when the neural network has to make sense of something complicated, contextual, or non-obvious, such as image recognition. The term “deep” learning comes from having many hidden layers. These layers are known as “hidden”, since they are not visible as a network output.

In certain embodiments, training a neural network may be described as calibrating all of the “weights” by repeating the forward propagation 1416 and the backward propagation 1422.

In backward propagation 1422, embodiments measure the margin of error of the output and adjust the weights accordingly to decrease the error.

Neural networks repeat both forward and backward propagation until the weights are calibrated to accurately predict the output 1424.

In certain embodiments, the inputs to the machine learning model 1400 are a state (of two or more vehicles) and a reward for an action, and the output of the machine learning model 1400 is a highest priority for a vehicle that is to pass through the intersection without stopping. In certain embodiments, the machine learning model 1400 may be refined based on whether the output generates positive outcomes.

In certain other embodiments, the inputs to the machine learning model 1400 are a state (of three or more vehicles) and a reward for an action, and the outputs of the machine learning model 1400 are a priority for each vehicle that determines an order in which the vehicles are to pass through the intersection. In certain embodiments, the machine learning model may be refined based on whether the outputs generate positive outcomes.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product, the computer program product comprising a computer readable storage medium having program instructions embodied therewith, the program instructions executable by a computer processor to cause the computer processor to perform operations comprising:
broadcasting, via wireless communication technology, a first traffic control message to a first vehicle and a second vehicle that are approaching an intersection;
receiving, via the wireless communication technology, a first vehicle status message from the first vehicle and a second vehicle status message from the second vehicle;
calculating a first energy consumption of the first vehicle to stop and accelerate to a particular speed based on the first vehicle status message;
calculating a second energy consumption of the second vehicle to stop and accelerate to the particular speed based on the second vehicle status message;
determining that the first energy consumption is greater than the second energy consumption;
sending, via the wireless communication technology, a second traffic control message to the first vehicle to proceed through the intersection without stopping; and
sending, via the wireless communication technology, a third traffic control message to the second vehicle to stop before entering the intersection until the first vehicle has cleared the intersection.

2. The computer program product of claim 1, wherein the program instructions are executable by the computer processor to cause the computer processor to perform further operations comprising:
determining that the first vehicle and a third vehicle are approaching the intersection;
calculating a third energy consumption of the third vehicle to stop and accelerate to the particular speed;
determining that the first energy consumption is less than the third energy consumption;
sending, via the wireless communication technology, a fourth traffic control message to the first vehicle to stop before entering the intersection until the third vehicle has cleared the intersection; and
sending, via the wireless communication technology, a fifth traffic control message to the third vehicle to proceed through the intersection.

3. The computer program product of claim 1, wherein the program instructions are executable by the computer processor to cause the computer processor to perform further operations comprising:
determining that the first energy consumption and the second energy consumption are equal; and
using one or more factors to determine which of the first vehicle and the second vehicle is to continue through the intersection without stopping, wherein the one or more factors comprise weather conditions, road conditions, camera feeds, traffic data, and vehicle data of the first vehicle and the second vehicle.

4. The computer program product of claim 1, wherein the determinations and calculations occur at an edge compute that is part of a traffic light and that receives data from the first vehicle and the second vehicle.

5. The computer program product of claim 1, wherein the first vehicle and a third vehicle communicate with vehicle to vehicle communications to determine which of the first vehicle and the third vehicle is to continue through the intersection without stopping.

6. The computer program product of claim 1, wherein the program instructions are executable by the computer processor to cause the computer processor to perform further operations comprising:
determining that three or more new vehicles are approaching the intersection;
ranking each of the new vehicles based on energy consumption associated with those new vehicles; and
sending, via the wireless communication technology, new traffic control messages to each of the new vehicles to indicate an order of entering the intersection.

7. The computer program product of claim 1, wherein a machine learning model receives inputs of a state and a reward for an action and outputs a highest priority for the first vehicle to indicate that the first vehicle is to proceed through the intersection without stopping.

8. A computer system, comprising:
one or more computer processors, one or more computer-readable memories and one or more computer-readable, tangible storage devices; and
program instructions, stored on at least one of the one or more computer-readable, tangible storage devices for execution by at least one of the one or more computer processors via at least one of the one or more computer-readable memories, to perform operations comprising:
broadcasting, via wireless communication technology, a first traffic control message to a first vehicle and a second vehicle that are approaching an intersection;
receiving, via the wireless communication technology, a first vehicle status message from the first vehicle and a second vehicle status message from the second vehicle;
calculating a first energy consumption of the first vehicle to stop and accelerate to a particular speed based on the first vehicle status message;
calculating a second energy consumption of the second vehicle to stop and accelerate to the particular speed based on the second vehicle status message;
determining that the first energy consumption is greater than the second energy consumption;
sending, via the wireless communication technology, a second traffic control message to the first vehicle to proceed through the intersection without stopping; and
sending, via the wireless communication technology, a third traffic control message to the second vehicle to stop before entering the intersection until the first vehicle has cleared the intersection.

9. The computer system of claim 8, wherein the operations further comprise:
determining that the first vehicle and a third vehicle are approaching the intersection;
calculating a third energy consumption of the third vehicle to stop and accelerate to the particular speed;
determining that the first energy consumption is less than the third energy consumption;
sending, via the wireless communication technology, a fourth traffic control message to the first vehicle to stop before entering the intersection until the third vehicle has cleared the intersection; and
sending, via the wireless communication technology, a fifth traffic control message to the third vehicle to proceed through the intersection.

10. The computer system of claim 8, wherein the operations further comprise:
determining that the first energy consumption and the second energy consumption are equal; and
using one or more factors to determine which of the first vehicle and the second vehicle is to continue through the intersection without stopping, wherein the one or more factors comprise weather conditions, road conditions, camera feeds, traffic data, and vehicle data of the first vehicle and the second vehicle.

11. The computer system of claim 8, wherein the determinations and calculations occur at an edge compute that is part of a traffic light and that receives data from the first vehicle and the second vehicle.

12. The computer system of claim 8, wherein the first vehicle and a third vehicle communicate with vehicle to vehicle communications to determine which of the first vehicle and the third vehicle is to continue through the intersection without stopping.

13. The computer system of claim 8, wherein the operations further comprise:
determining that three or more new vehicles are approaching the intersection;
ranking each of the new vehicles based on energy consumption associated with those new vehicles; and
sending, via the wireless communication technology, new traffic control messages to each of the new vehicles to indicate an order of entering the intersection.

14. The computer system of claim 8, wherein a machine learning model receives inputs of a state and a reward for an action and outputs a highest priority for the first vehicle to indicate that the first vehicle is to proceed through the intersection without stopping.

15. A computer-implemented method, comprising operations for:
broadcasting, via wireless communication technology, a first traffic control message to a first vehicle and a second vehicle that are approaching an intersection;
receiving, via the wireless communication technology, a first vehicle status message from the first vehicle and a second vehicle status message from the second vehicle;
calculating a first energy consumption of the first vehicle to stop and accelerate to a particular speed based on the first vehicle status message;
calculating a second energy consumption of the second vehicle to stop and accelerate to the particular speed based on the second vehicle status message;
determining that the first energy consumption is greater than the second energy consumption;
sending, via the wireless communication technology, a second traffic control message to the first vehicle to proceed through the intersection without stopping; and
sending, via the wireless communication technology, a third traffic control message to the second vehicle to stop before entering the intersection until the first vehicle has cleared the intersection.

16. The computer-implemented method of claim 15, further comprising operations for:
determining that the first vehicle and a third vehicle are approaching the intersection;
calculating a third energy consumption of the third vehicle to stop and accelerate to the particular speed;
determining that the first energy consumption is less than the third energy consumption;
sending, via the wireless communication technology, a fourth traffic control message to the first vehicle to stop before entering the intersection until the third vehicle has cleared the intersection; and
sending, via the wireless communication technology, a fifth traffic control message to the third vehicle to proceed through the intersection.

17. The computer-implemented method of claim 15, further comprising operations for:
determining that the first energy consumption and the second energy consumption are equal; and
using one or more factors to determine which of the first vehicle and the second vehicle is to continue through the intersection without stopping, wherein the one or more factors comprise weather conditions, road conditions, camera feeds, traffic data, and vehicle data of the first vehicle and the second vehicle.

18. The computer-implemented method of claim 15, wherein the determinations and calculations occur at an edge compute that is part of a traffic light and that receives data from the first vehicle and the second vehicle.

19. The computer-implemented method of claim 15, wherein the first vehicle and a third vehicle communicate with vehicle to vehicle communications to determine which of the first vehicle and the third vehicle is to continue through the intersection without stopping.

20. The computer-implemented method of claim 15, further comprising operations for:
determining that three or more new vehicles are approaching the intersection;
ranking each of the new vehicles based on energy consumption associated with those new vehicles; and
sending, via the wireless communication technology, new traffic control messages to each of the new vehicles to indicate an order of entering the intersection.
